(19) United States
(12) Patent Application Publication
(10) Pub. No.: US 2022/0300602 A1
(43) Pub. Date: Sep. 22, 2022

(54) Method Of Automated Registration

(71) Applicant: Ilya Vladimirovich Redkokashin, Rostov-on-Don (RU)

(72) Inventor: Ilya Vladimirovich Redkokashin, Rostov-on-Don (RU)

(21) Appl. No.: 17/638,141

(22) PCT Filed: Aug. 3, 2020
(86) PCT No.: PCT/RU2020/000407

§ 371 Date: Feb. 24, 2022

(30) Foreign Application Priority Data
Aug. 24, 2019 (RU) 2019126766

(51) Int. Cl. G06F 21/45

(52) U.S. Cl. CPC G06F 21/45; G06F 2221/2117

(57) ABSTRACT

The invention refers to computer networks field, particularly to registration methods. To be exact the invention treats to users registration methods with using users personal devices, which have an ability to transfer data.

The method of automated registration includes in itself, acceptance from user information about personal device which have an ability to transfer data, or acceptance from user an image, then creating or acceptance from user information which is necessary in farther to log in of user in account which will be created, farther by means of server automatically creating of contact information and registering user, wherein user do not get contact information, after that assigns contact information to personal device which have an ability to transfer data, or assigning contact information to an image, thus, that the user can by means of personal device which have an ability to transfer data, or by means of image transfer hidden contact information to other users for connection.

Proposed invention provides users registration, providing heightened confidentiality of created while registration contact information.

### FIELD OF TECHNOLOGY

The invention refers to the field of computer networks, in particular to the methods of registration. Specifically the invention refers to the methods of users registration with using of users personal devices which have an ability to transmit data.

### PRECEDING LEVEL OF TECHNOLOGY

In present for creating credentials, use information which gaven from user, such as login or password, used in farther to enter user in his account. Besides identifiers assigns for users, which users exchange for connection between each other. Right after the registration for user report his identifier.

Such method is convenient for regular registrations of users, but it's doesn't suit for users registration, who wishing to control his contact information, because to control contact information it is necessary that this information will be hidden, and for it's transfer it is necessary to have a resource which only user possess.

The task, set by the developer to himself, of the method of automated registration, consists in development of the method, which in comparison due to analogues will allow to register users providing heightened confidentiality of created while registration contact information.

Technical result of mentioned method of automated registration, is users registration, providing heightened confidentiality of created while registration contact information.

### DISCLOSURE OF INVENTION

The essence of the method of automated registration consist in that, that by means of registration points, or by means of personal electricity computing devices from user get information about personal device of user which have an ability to transfer data, or from user is receiving an image, then creating or receiving from user information which necessary in farther to enter while creating credentials, farther by means of server automatically creating user's contact information and his registering, wherein contact information for user is not providing, farther contact information is assigning to a personal device of user which have an ability to transfer data, or contact information is assigning to an image, thus, that the user could by means of personal device which have an ability to transfer data, or by resources of an image to transfer hidden contact information to other users for communication.

Registration can be conducted for e-mail services, and as contact information using e-mail name or messenger or social network, and as contact information serves user page, or his nickname, or login, or phone number. Loging in, in credential can be provided by user personal device, which have an ability to transfer data or biometric data, which is requesting during registration. Registration can be conduct in mobile operator system, and a phone number could be used as a contact information.

### AN EXAMPLE OF A SPECIFIC APPLICATION OF THE INVENTION

Claimed method of automated registration, also can it be called as the method of creating credentials, or the method of security procuring and controlling contact information, is as follows. For realization of claimed method from user by means of the server is requesting information about user's personal device which have an ability to transfer data, for example such device can be short range sensor, which is a part of mobile device, or for example a part of subcutaneous chip or e-passport and so on. Or by means of server requested an image or QR-code, barcode, picture and etc, which user can print for example on sticker. Wherein an image can't be symbols which directly mean contact information, and also image can't be a users biometric data. That is accepts an image, which is not users biometric data and is not a contact information. Also from users accepts information which is necessary for registration, such as created by user login, password, Name Surname Patronymic and other data. Also could be requested only information about personal device which have an ability to transfer data or an image can be requested, and any other data, such as login and password generates automatic and give users later, in case if user need them. User with the help of personal electricity computing devices such as for example mobile phones, tablets, PC and so on and internet transfer requested information to the server. Also needed data for users registration can be accepts on registration points, for example such points as mobile operator registration point, where staff entering all data in to computer, which transfer data to the server.

After getting and the necessary data by one of above mentioned methods, server automatically registering linking user contact information to a user personal device, which have an ability to transfer data, or registering linking contact information to an image, in a way that user in farther can transfer contact information with the help of a device, which have an ability to transfer data or transferring contact information with the help of an image. Wherein the contact information hidden from everybody, including the user.

For better understanding, what gives such registration let's show what will happened after registration, described in invention. For transfer contact information to other users, registered user will use personal device which have an ability to transfer data to which contact information was linked, wherein the contact information will be hidden always. Contact information on all devices will be hidden and externally will be look as an icon, by pressing on which contact will happened. During contact information transfer, for examination can be also requested other automatically generated information, such as for example user's geolocation. Image or personal device which have an ability to transfer data, can transfer hidden contact information, either for example can transfer information for connection with serve, which upload on users device hidden contact information.

For mentioned above method of the contact information transferring better fits described in invention the method of automated registration. Such registration can be provided in messengers, e-mail services, social networks, mobile operators and any other services who creating users contact information.

Wherein for users log in, in account can be used biometric users data.

1. The method of automated registration, in which at first by means of registration points, or personal electricity computing devices, from user receiving information about personal device of user which have an ability to transfer data, or from user receiving an image, then creating or receiving from user information which necessary in farther for user entering in account which will be created in future, after that by means of server automatically creating contact information of user and registering the user, while do not giving contact information to user, then the contact information is assigning to the user's personal device which have an ability to transfer data, or the contact information is assigning to the image, thus, that the user can by means of a personal device which have an ability to transfer data, or by means of an image, transfer hidden contact information to other users for communication.

2. The method of automated registration based on claim 1, wherein, registration is happening for e-mail service, and as contact information is using name of e-mail.

3. The method of automated registration based on claim 1, wherein registration is happening for messenger or social network, and contact information serves a user page, or nickname, or login, or phone number.

4. The method of automated registration based on claim 1, wherein log in, in credentials is providing with the help of personal device which have an ability to transfer data or biometric data, which is requesting while registration.

5. The method of automated registration based on claim 1, wherein registration is occurring in mobile operator system, as contact information is a mobile phone number.
